(19) United States
(12) Patent Application Publication
(10) Pub. No.: US 2005/0238171 A1
(43) Pub. Date: Oct. 27, 2005

(54) Application authentication in wireless communication networks

(76) Inventors: Lidong Chen, Palatine, IL (US); Balakumar Jagadesan, Glendale Heights, IL (US)

Correspondence Address: MOTOROLA INC, 600 NORTH US HIGHWAY 45, ROOM AS437, LIBERTYVILLE, IL, 60048-5343, US

(21) Appl. No.: 10/831,808

(22) Filed: Apr. 26, 2004

(51) Int. Cl. H04L 9/00

(52) U.S. Cl. 380/270

(57) ABSTRACT

A method in wireless communications devices including generating a lower layer cipher key from a lower layer access key stored on the wireless communications device, for example, on a smart card, and then generating a higher layer authentication key (210) from the lower layer cipher key (230). The higher layer authentication key is also generated at a network entity and delivered to an authentication and authorization server. An application server authenticates subscriber device service requests with the authentication and authorization server using the higher layer authentication key.

### FIELD OF THE DISCLOSURE

The present disclosure relates generally to wireless communications, and more particularly to service access authentication in wireless communications networks, for example, push-to-talk over cellular service request in cellular communications networks.

### BACKGROUND OF THE DISCLOSURE

Press/Push-to-Talk over Cellular (PoC) communications networks Architectures are known generally. The “Push-to-Talk over Cellular (PoC) Architecture”, v1.1.0, Release 1.0. defined by Ericsson et al., for example, is based on an Internet Protocol Based Multimedia Subsystem (IMS) core specified in 3GPP TS23.228 “IP Based Multimedia Subsystem (IMS) Stage 2”, Release 6. Version 6.4.1, 2004-01 and in 3GPP TS 24.229 “IP Multimedia Call Control based on Session Initiation Protocol (SIP) and Session Description Protocol (SDP) Stage 3” Release 6. Version 6.1.1. 2003-12. The IMS is an all-Internet Protocol (IP) wireless system where data, voice and signaling are all carried as IP packets. However, authentication and security protections in these and other Push-to-Talk architectures cannot depend on IMS security features where Authentication and Key Agreement (AKA) based IMS security protocols are not implemented. Authentication and Key Agreement (AKA) is a new generation security scheme being developed for 3GPP2 CDMA2000 systems and 3GPP UMTS systems.

Presently, in order to secure Press/Push-to-Talk over Cellular (PoC) service, access authentication must be conducted between the user equipment (UE) and Application Server (AS). Messages between the UE and IP Based Multimedia Subsystem (IMS) core, for example, from the UE to a Proxy Call Session Control Function (P-CSCF), which is a first contact point for a terminal within the IMS, must be protected for confidentiality and integrity. For call set up, PoC uses Session Initiation Protocol (SIP), which is an Internet Engineering Task Force (IETF) Standards setting body protocol for packetized voice (VoIP) call processing, to establish a session. According to one SIP authentication method, the UE and Application Server use a Hypertext Transfer Protocol (HTTP) digest. The HTTP digest is computed via a hash function, like MD5, with secret information called a key (or password), which has a relatively short lifespan.

Siemens has proposed Hypertext Transfer Protocol (HTTP) digest password distribution through the Internet Protocol Based Multimedia Subsystem (IMS) core wherein passwords are generated by the Home Subscriber Server (HSS) and distributed to the user equipment (UE) through the Serving Call Session Control Function (S-CSCF), which handles IMS session states, and to the Application Server (AS), which handles applications for a range of addresses. The Siemens solution requires distribution of the password or key over the air interface to the UE. Nokia has also proposed key or password distribution via an over-the-air protocol. In some PoC applications, over-the-air (OTA) key or password distribution is undesirable. Additionally, the relatively short duration of key and password validity requires frequent over-the-air key or password updates.

Ericsson has proposed service request via HTTP without cryptographic authentication except for the execution of Transport Layer Security (TLS) between User Equipment (UE) and Proxy Call Session Control Function (P-CSCF). With this method, upon execution of the TLS, a protected channel between the UE and P-CSCF is produced. TLS depends on Public Key Infrastructure (PKI) for authentication and public key operations for key agreement. Under the Ericsson proposal, however, application service request messages delivered by HTTP are susceptible to a man-in-the-middle attack.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates an exemplary wireless data communications network.

FIG. 2 illustrates an exemplary process for generating a higher layer authentication key or password.

FIG. 3 illustrates exemplary signaling between entities in an exemplary data communications network.

FIG. 4 illustrates exemplary signaling between entities in an exemplary data communications network and a higher layer authentication server.

FIG. 5 also illustrates exemplary signaling between entities in an exemplary data communications network using a key (or password) for service access authentication.

### DETAILED DESCRIPTION

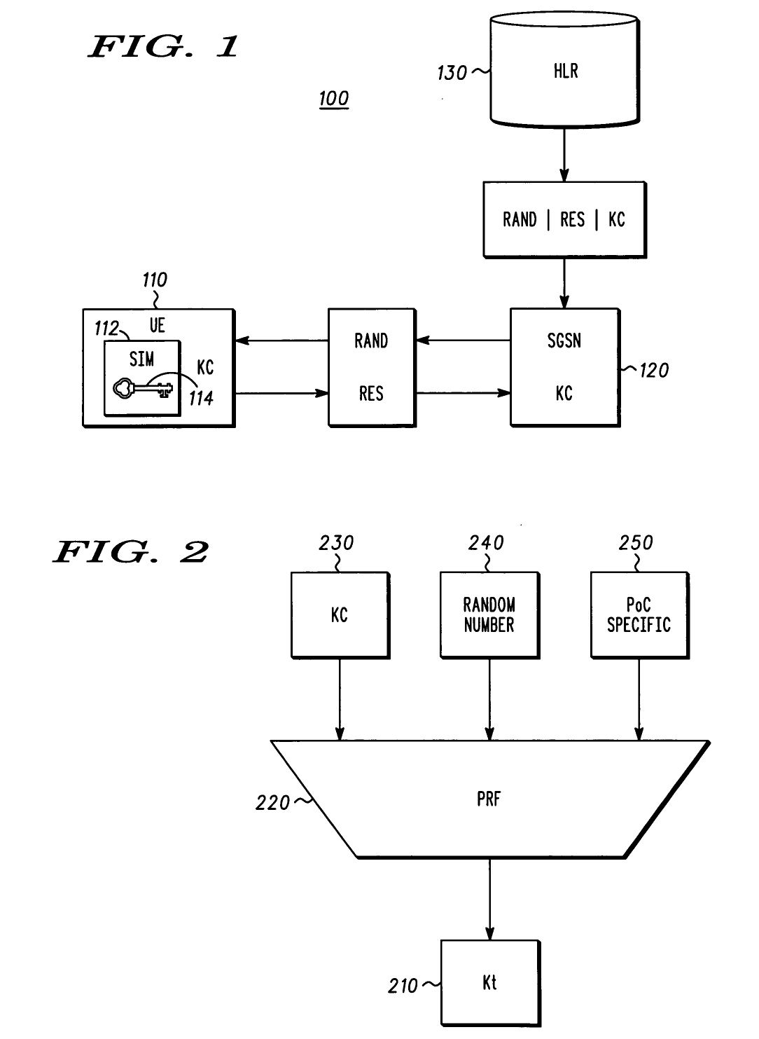

In FIG. 1, the exemplary Global System for Mobile Communications (GSM)/Serving General Packet Radio Service (GPRS) wireless communications network 100 comprises generally a wireless device or user equipment (UE) 110 that communicates with a Serving General Packet Radio Service (GPRS) support node (SGSN) 120 via GSM wireless infrastructure, including a base station control (BSC) and base transceiver stations (BTS) among other entities that are well known to those having ordinary skill in the art but not illustrated in FIG. 1. In FIG. 1, the SGSN 120 also communicates with a home location register (HLR) 130, as discussed further below. The exemplary user equipment 110 could be a mobile or stationary wireless device or a personal digital assistant or a wireless enabled laptop or compact computing device or some other wireless communications device.

In other embodiments, the wireless communications network is a CDMA network and the entities are known by different names. In CDMA networks for example the entity 120 is known as a Packet Data Serving Node (PDSN). The alternative CDMA network also includes wireless infrastructure. In other embodiments, the communications network is a 3^{rd} Generation (3G) Universal Mobile Telecommunications System (UMTS) W-CDMA wireless communications network or a future generation communications network.

In some embodiments, the wireless communications device includes a lower layer access key for accessing lower layer entities of the architecture, for example, the radio interface. The lower layer access key is a long-term key that changes relatively infrequently, if at all.

In FIG. 1, the exemplary user equipment 110 includes a removable GSM Subscriber Identification Module (SIM) 112 or some other smart card on which the lower layer access key 114 is stored. In other exemplary embodiments, for example, the lower layer access key is stored on a User Identification Module (UIM) or some other smart card. In other embodiments, the lower layer access key is stored in some other memory of the device, for example, in RAM, ROM, EPROM, etc. without requiring a smart card.

In some embodiments, the user equipment (UE) generates other lower layer keys, for example, cipher keys. In one embodiment, the cipher key is generated based on the lower layer access key. The cipher and other lower layer keys are relatively short-term keys (compared to the lower layer access keys) used for encryption, at the link layer of the architecture, etc. as is known generally by those having ordinary skill in the art. Exemplary FIG. 1 illustrates a cipher key, K_{C}, generated on the UE. In existing GSM UE, the cipher key is generated in or on the SIM. The cipher key is preferably not distributed to the UE by other means over the air, although in some embodiments it could be.

In some embodiments, the user equipment (UE) also generates a higher layer authentication key or password based on, or from, the cipher key. The higher layer authentication key is used for authentication at higher layers in the architecture, for example, for authenticating applications as discussed further below. In FIG. 2, for example, the higher layer authentication key, Kₜ, 210 is generated based on, or from, the cipher key, K_{C}, 230 using a pseudorandom function (PRF) 220. In FIG. 2, the exemplary generation of the higher layer authentication key, Kₜ, 210 is also based on other information, for example, on random number 240 and/or on other specific information 250. In embodiments where the higher layer authentication key is used to authenticate a press/push-to-talk (PoC) application, the other information 250 is specific to the PoC application, as illustrated in FIG. 2. In other embodiments, the higher layer authentication key, Kₜ, is generated based upon information related to another application.

In the exemplary push-to-talk authentication application, the higher layer authentication key, Kₜ, is independently generated at the UE and at the Serving GPRS support node (SGSN) or at the Packet Data Serving Node (PDSN) in CDMA networks or other entity with which the UE will communicate during the authentication process. Independent generation of the higher layer authentication key is possible where entities have the same information from which the higher layer authentication key is generated.

In the exemplary GSM architecture, the higher layer authentication key, Kₜ, is generated using RAND and RES as inputs since this information is known by both the UE and SGSN. RAND is a random number used for authentication purposes, and RES is an authentication response, or a value calculated from a secret key and a random number that can be used to infer that the respondent is in possession of the secret key without revealing it, as illustrated in FIG. 1. In FIG. 1, for example, the SGSN 120 obtains the RAND and RES information from the home location register (HLR) 130. With this information, the UE 110 and the SGSN 120 are both able to generate the same higher layer authentication key, Kₜ.

In the exemplary SIP based authentication of the push-to-talk (PoC) application, a Hypertext Transfer Protocol (HTTP) digest is computed based upon a higher layer authentication key. In applications where an HTTP digest is required, the higher layer authentication key is the HTTP digest key or password. In other applications, the higher layer authentication key may be used to generate some other password or key or token, depending on the requirements of the particular application and on the authentication mode. By generating the application authentication key using only information stored on the entity, the need to transmit the HTTP digest key or password is eliminated.

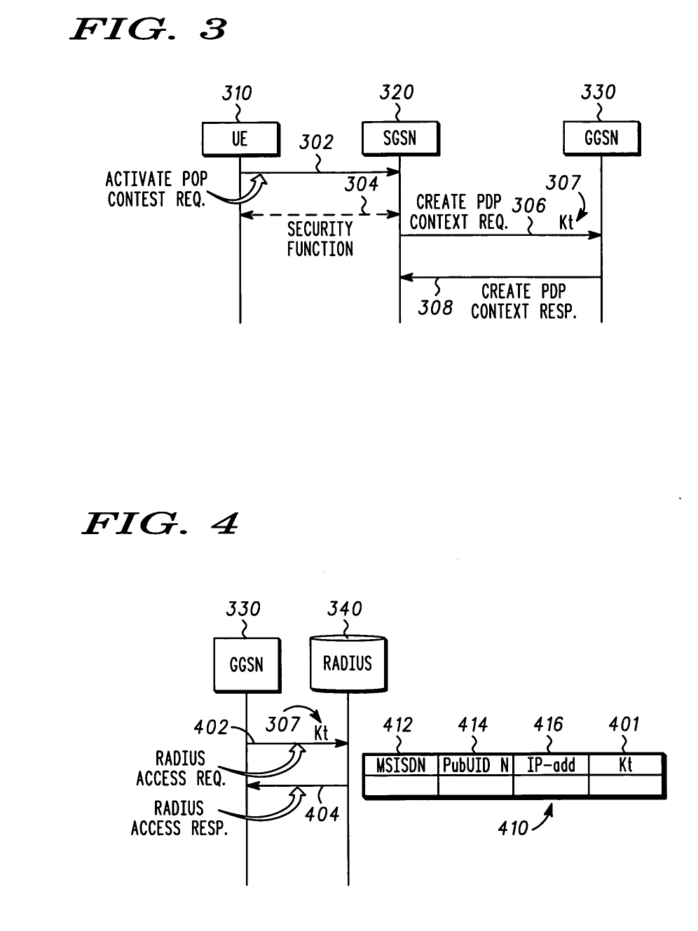

In FIG. 3, in General Packet Radio Service (GPRS) applications, the user equipment (UE) 310 communicates or transmits an Activate PDP context request 302 to the serving GPRS support node (SGSN) 320 and security functions, e.g., authentication, etc., are communicated subsequently. In GSM/GPRS architectures, for example, SIM based GPRS authentication is performed pursuant to 3GPP TS 03.60 “Digital Cellular Telecommunications System (Phase 2+)—General Packet Radio Service (GPRS) Service Description stage 2.” Release 1998. Version 7.9.0. 2002-09. At this time, the SGSN receives the cipher key, K_{C}, information from the HLR and computes the higher layer authentication key, Kₜ, as discussed above.

In the exemplary process of FIG. 3, the SGSN 320 attaches the higher layer authentication key, Kₜ, to a “Create PDP Context Request” message 306 and sends it to the Gateway GPRS Support Node (GGSN) 300 as specified in GSM 03.60 v6.2.0 section 9.2.2.1. In the exemplary embodiment, the message includes Access Point Name (APN), Quality of Service (QoS), TID, PDP-Type, and other information. The higher layer authentication key 307 is an additional component for the message to carry. It is referred to as an “attachment” to indicate that it is an added component to the original message defined in GSM03.60. The GGSN should be aware of the attachment. In some embodiments, the GGSN stores the higher layer authentication key for the next step. In some embodiments, the GGSN confirms receipt of the attachment in a “Create PDP Context Response” message 308. In other communications architectures, the higher layer authentication key may be sent with or attached to some other message sent to a different entity.

In FIG. 4, the Gateway GPRS Support Node (GGSN) 330 sends the higher layer authentication key to a Remote Authentication Dial In User Service (RADIUS) server 340. In other embodiments, the higher layer authentication key is sent to an authorization or authentication entity, for example, an Authentication, Authorization and Accounting (AAA) entity. In the exemplary embodiment, the higher layer authentication key 501 is sent to the RADIUS server with one of the RADIUS access-request messages 502 defined in 3GPP TS 29.061, “Interworking between the Public Land Mobile Network (PLMN) supporting packet based services and Packet Data Networks (PDN)” Release 5. Version 5.8.0. 2003-12. The higher layer authentication key is stored at the RADIUS server or at the other entity to which the key is sent for later use, as discussed further below.

In FIG. 4, at the authorization and authentication entity 340, the higher layer authentication key 401 is stored together with other information 410 for the given UE, for example, MSISDN 412, PubUID 414, IP address 416, etc. Generally, the association or bundling of the higher layer authentication key with the other information is performed at another entity, for example, at the GGSN 330, prior to transmission of the higher layer authentication key to the authorization or authentication entity 340. The exemplary RADIUS entity sends a RADIUS access response 404 to the entity from which the RADIUS access request 402 is received.

In other alternative embodiments, the higher layer authentication key is sent directly to the authorization and authentication server by the entity that generated the key. The higher layer authentication key is also bundled with any other information at the generating entity.

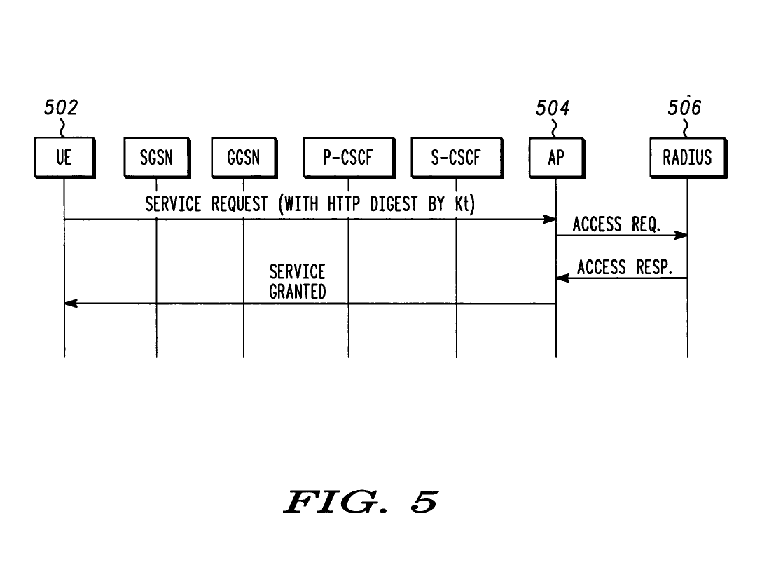

In FIG. 5, the user equipment (UE) 502 transmits a service request, for example, a push-to-talk request, to an application server (AP) 504. More generally, the service request may be for any application accessed over a packet network or otherwise. In the exemplary embodiment, the service request includes the HTTP digest produced using the higher layer authentication key. Upon receipt of the HTTP digest, the application server 504 executes the RADIUS or other protocol with the RADIUS server or other authorization entity 506, respectively, to authenticate and authorize the service using the stored higher layer authentication key.

The exemplary process provides information, in the exemplary form of higher layer authentication key or password, required to authenticate an application service request, without requiring over-the-air transmission of the information. In the exemplary application, the UE accesses a GPRS network using SIM based authentication. The proposed solution uses the cipher key established during GPRS authentication to derive a key or password at the UE and at the SGSN. The key is delivered to GGSN via PDP context request message, and the GGSN then sends the key together with other information of UE to a Radius server, which stored the key for later authenticating service requests by HTTP digest.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method in a wireless communications device including a lower layer access key, the method comprising:
generating a lower layer cipher key from the lower layer access key of the wireless communications device,
generating a higher layer authentication key from the lower layer cipher key.

2. The method of claim 1,
authenticating a packet network using the lower layer access key,
generating a lower layer cipher key from the lower layer access key used to authenticate the packet network.

3. The method of claim 2,
generating a digest using the higher layer authentication key,
transmitting a service request including the digest to a network entity upon starting an application with which the higher layer authentication key is associated.

4. The method of claim 1,
generating the higher layer authentication key from the lower layer cipher key includes generating an HTTP digest password from the lower layer cipher key, the higher layer authentication key is the HTTP digest password.

5. The method of claim 4, using the HTTP digest password for a Session Initiation Protocol authentication.

6. The method of claim 1, using the higher layer authentication key to authenticate a push-to-talk session.

7. A method in a wireless communications device, the method comprising:
generating a cipher key using a lower layer authentication key stored on the wireless communications device;
generating an application authentication key from the cipher key, the application authentication key associated with an application;
authenticating the application using the application authentication key.

8. The method of claim 7,
authenticating a packet network using the lower layer authentication key,
generating the application authentication key upon authenticating to the packet network.

9. The method of claim 8,
the application authentication key is an HTTP digest password,
authenticating the packet application using an HTTP digest derived from the HTTP digest password.

10. The method of claim 8,
the application is a push-to-talk application,
authenticating the push-to-talk application using the application authentication key.

11. The method of claim 7, generating the application authentication key using only information, including the cipher key, stored on the wireless communications device.

12. A method in a wireless communications network, the method comprising:
generating a cipher key for lower layer encryption at the a first network entity;
generating an application authentication key at the first network entity using the cipher key;
sending the application authentication key along with a network signal message to a second network entity.

13. The method of claim 12, appending the application authentication key to the network signal message before sending the network signal message to the second network entity.

14. The method of claim 12,
sending an access request and the application authentication key from the second entity to a third network entity associated with application authentication,
storing the application authentication key at the third entity.

15. The method of claim 14,
bundling the application authentication key with related higher layer identification information before sending the application authentication key to the third network entity,
storing the application authentication key and the related higher layer identification information at the third entity.

16. The method of claim 15,
receiving an application access authentication key at the third entity from a network application entity,
providing a response to the network application entity from the third entity in response to receiving the application access authentication key.

17. A method in a wireless communications network application authentication entity, the method comprising:
receiving an application access request and an authentication message of a subscriber device from an application entity;
verifying the application authentication message at the authentication entity using an application authentication key stored at the authentication entity;
providing an access response to the application entity in response to receiving the application access request, the access response based on verification of the application authentication message.

18. The method of claim 17,
the application access request including an HTTP digest from the subscriber device,
verifying the HTTP digest using the application authentication key stored at the authentication entity;
sending the access response based on a comparison of a computation of the HTTP digest using the application authentication key stored at the authentication entity with the digest received from the subscriber device.
